(19) United States
(12) Patent Application Publication
(10) Pub. No.: US 2004/0194295 A1
(43) Pub. Date: Oct. 7, 2004

(54) Nano-electrochemical cells

(76) Inventor: Mino Green, London (GB)

Correspondence Address: Jay F Moldovanyi, Fay Sharpe Fagan Minnich & McKee, 7th Floor, 1100 Superior Avenue, Cleveland, OH, 44114-2518, US

(21) Appl. No.: 10/482,068

(22) PCT Filed: Jun. 20, 2002
(86) PCT No.: PCT/GB02/02819

(30) Foreign Application Priority Data
Jun. 29, 2001 (GB) 0116057.1

(51) Int. Cl. H01M 10/04

(52) U.S. Cl. 29/623.1; 29/623.5

(57) ABSTRACT

A method of forming an array of electrically addressable cells includes the steps of (a) forming a set of parallel conductor strips extending in a first direction on an insulating substrate; (b) forming an insulating layer superimposed on the first series of parallel strips; and (c) forming a second set of parallel conductor strips extending in a direction at right angles to the first direction superimposed on the insulating layer so as to form crossover regions between the strips. Thereafter, (d) wells are formed in the structure which extend through the conductor strips so that the wells at the crossover regions can be addressed electrically in the conductor strips. The addressable array of cells can then be used for selectively reacting a substance with a series of different reagents by a method which involves addressing selected groups of cells with electrical signals using the matrix of conductor strips. An electrolyte is applied to the array in such a way that the selected cells can be either shuttered by gas bubbles formed by the electrolyte, to protect them from reaction, or can be subjected to a local change in pH which promotes a reaction. In this way, a matrix of chemicals can be synthesized so that the composition and spatial position is known for each component of the matrix.

This invention relates to a method of fabricating nanometer sized electrochemical cells in a multilayer substrate. In particular, it is concerned with a method of fabricating an electrically addressable array of cells that will find particular application in combinatorial synthesis.

In the process of combinatorial synthesis, it is required to experimentally combine various different chemicals, in large numbers of alternative combinations, in order to investigate possible useful compounds that may result. Consequently, it is desirable to provide a method of at least partially automating the process whereby the different substances can be spatially isolated and identified.

Accordingly, a first aspect of the present invention provides a method of forming an array of electrically addressable cells, comprising the steps of:

(a) forming a set of parallel conductor strips, extending in a first direction, on an insulating substrate;

(b) forming an insulating layer superimposed on the first series of parallel strips;

(c) forming a second set of parallel conductor strips, extending in a direction at right angles to the first direction, superimposed on the insulating layer so as to form crossover regions between the strips, and

(d) forming wells in the structure which extend through the conductor strips, so that the wells at the crossover regions can be addressed electrically via the conductor strips.

The wells may be formed by the process of “island lithography” described in our copending International patent application, publication no. 01/13414. This describes a method for producing an array of “wells” in a substrate, which comprises the steps of:

a) depositing a very thin film of a highly soluble solid onto a flat hydrophilic substrate;

b) exposing the film to solvent vapour under controlled conditions so that the film reorganises into an array of discrete hemispherical islands on the surface;

c) depositing a film of a suitable conductive resist material over the whole surface;

d) removing the hemispherical structures together with their coating of resist leaving a resist layer with an array of holes corresponding to the islands; and

e) subjecting the resulting structure to a suitable etching process so as to form a well at the position of each hole.

The highly soluble solid may be a salt such as cesium chloride, in which case the solvent used will be water. Preferably the resist material is aluminium, silver, or chromium which may be vapour-deposited. In a preferred embodiment the removal of the coated hemispherical structures is achieved by submerging the structure in an ultrasonic agitation bath filled with solvent, the agitation combined with the dissolving of the islands having the effect of removing the thin layer of material in which they were coated. This leaves a perforated film over the rest of the substrate, namely covering the “ocean” area in which the islands are located. This process step is known as a “lift-off” process. This perforated film whose holes correspond to the now removed islands can act as a resist in an etching process.

In the above mentioned application, the method is described primarily, as a means of fabricating semiconductor devices in a silicon substrate, but it is also applicable to other kinds of substrates, and may, for example, be utilised in order to form wells in a suitable multilayer structure of electrodes, so as to provide a multiplexed array of electrochemical cells, as described above.

Alternatively the wells may be formed by various other known semiconductor fabrication techniques such as electron beam lithography, x-ray lithography, or deep UV lithography.

According to a second aspect of the invention, there is provided a method of selectively reacting a substance with a series of different reagents using an electrically addressable array of cells including a matrix of contract strips, the method comprising the steps of:

(a) introducing the substance into the array of cells so as to be bound to and form a reaction site in each cell;

(b) applying moderately acidic electrolyte to the array, in order to fill all of the cells with electrolyte;

(c) connecting an electrical supply to at least two intersecting contact strips of the array, so as to address the corresponding group of cells at the crossover region or regions; whereby the water of the electrolyte is electrolysed to produce a gas bubble at each cell which protects the reaction site;

(d) applying a reagent onto the array of cells so that it can only react with the cells which have not been addressed.

According to a third aspect of the invention there is provided a method of selectively reacting a substance with reagents using an electrically addressable array of cells including a matrix of contact strips, the method comprising the steps of:

(a) introducing the substance into the array of cells so as to be found to and form a reaction site in each cell;

(b) applying a near-neutral electrolyte solution to the array, in order to fill all of the cells with electrolyte;

(c) connecting an electrical supply to at least two intersecting contact strips of the array, so as to address the corresponding group of cells at the crossover region or regions; whereby the pH of the solution is changed locally in the reaction site of each addressed cell, so that the bound substance becomes receptive to a reagent.

Preferably, the side walls of the cells are treated so as to be hydrophilic.

One embodiment of the invention will now be described, by way of example, with reference to the accompanying drawings, in which:

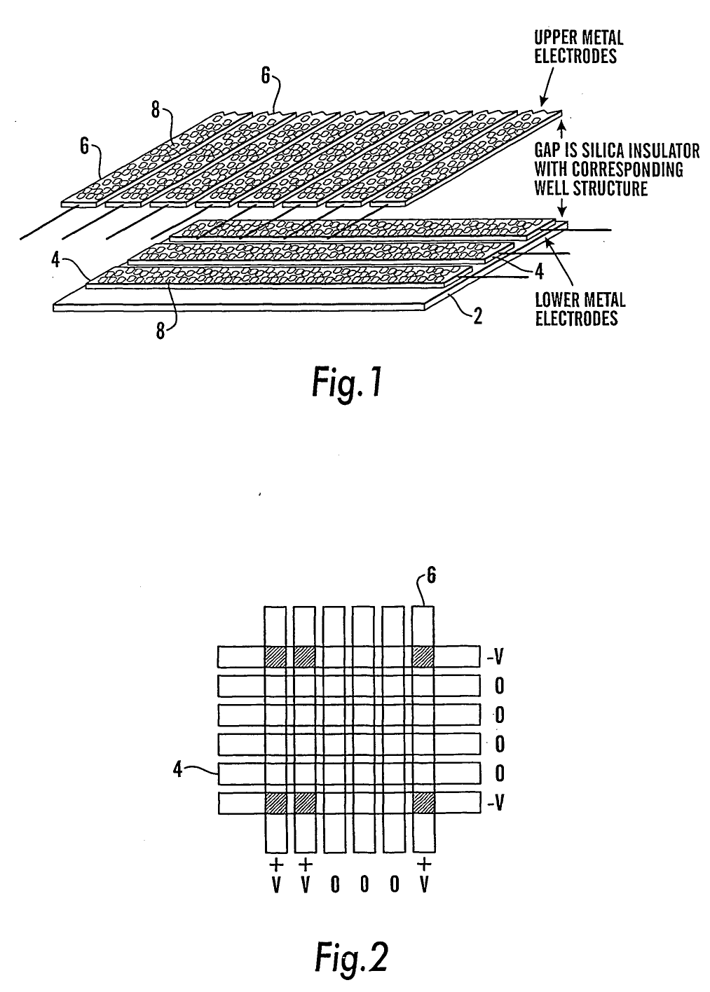

FIG. 1 is a diagrammatic view of the layer structure of the device according to the invention;

FIG. 2 is a plan view of a multiplexed array of cells;

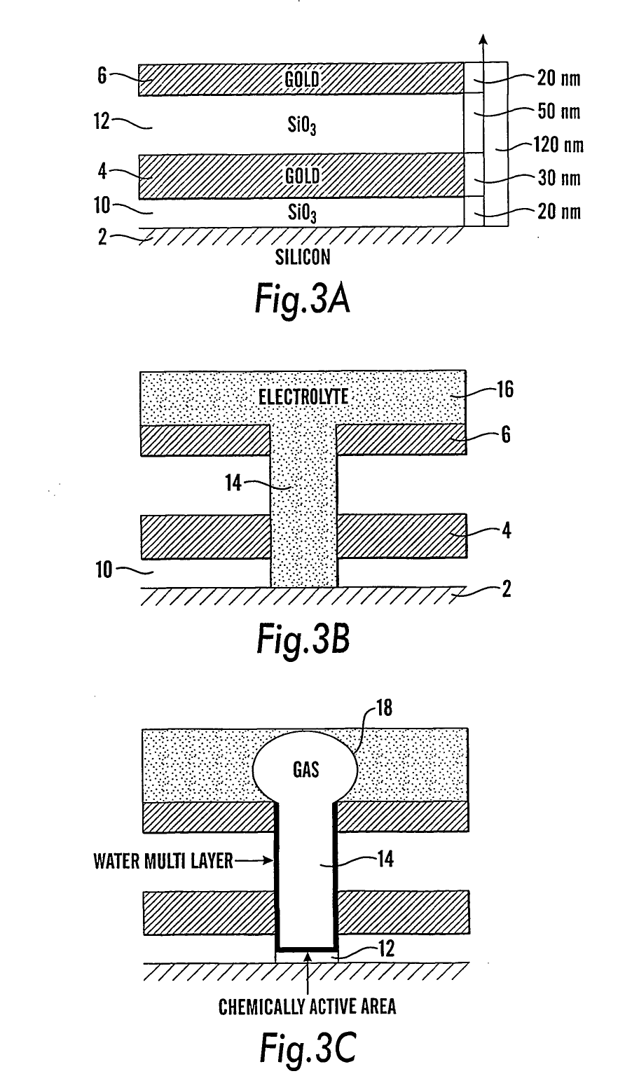

FIG. 3a is a vertical cross section through the multilayer cell structure of FIG. 1;

FIG. 3b is a cross section corresponding to that of FIG. 3a, and showing wells filled with electrolyte;

FIG. 3c illustrates the well structure with a gas column isolating material at the bottom of the well, from the electrolytic reagent;

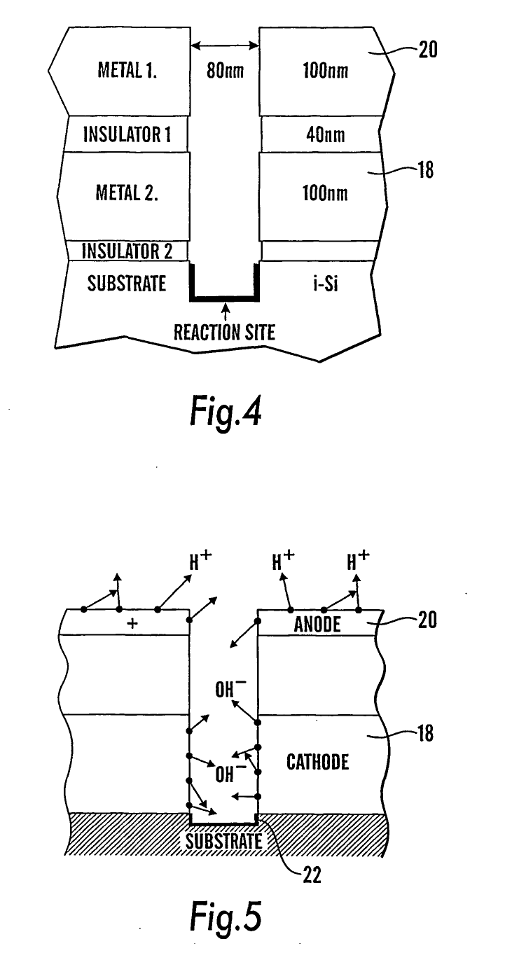

FIG. 4 shows a cross-section through a further well structure; and

FIG. 5 shows an electrochemical reaction in the cell.

FIG. 1 illustrates an “exploded” view of the multiplexed cell structure, which is formed on a substrate 2 which may be, for example, silicon with an insulating layer of SiO₂. A set of parallel conductive metal strips 4 is formed on the substrate, for example by a suitable photolithographic process, upon which is superimposed a further insulating layer such as SiO₂ (not shown in FIG. 1), and a further set of parallel conductive strips 6 is then formed on the silica insulating layer, extending at right angles to the first set of strips 4.

Accordingly, this provides a rectangular array of conductors, shown in plan view in FIG. 2, and it will be appreciated that each individual region at the interstices of the strips can therefore be addressed electrically, by applying a suitable potential across one of the strips of each set. As shown in FIG. 2, a voltage +V has been applied to three of the strips 6, while a voltage of −V has been applied to two of the strips 4, thereby subjecting six shaded regions to the array to the corresponding difference in potential.

As indicated by the pattern A of apertures in the electrode strips 4 and 6 in FIG. 1, the structure has also been formed overall with a large number of wells by the process of “island lithography” described in more detail above, or by another suitable semiconductor fabrication technique. FIGS. 3a to 3c illustrate an enlarged cross-sectional view of the structure, at the intersection of two of the strips 4 and 6, to show how the cells may be formed and utilised in practice. In this example an insulating layer of silicon dioxide 10, having a depth of about 20 nanometers, is formed on the silicon substrate 2, and the strips 4, which in the example are made of gold, are deposited to a thickness of approximately 30 nanometers on the insulator 10. A further insulating layer 12 of SiO₂, having a depth of approximately 50 nanometers is superimposed on the electrodes 4.

The resulting structure is then processed to form a number of wells at each intersection, only one of which is shown in FIG. 3b. In this example, the metal conductive strips are approximately one micron wide, and the diameter of each well is about 50 nanometers and has a depth of 120 nanometers. The process forms cells at a density of about 100 per sq. micron. Chemicals are then sited at the bottom of the wells 14 to create reaction zones 12.

The structure may be arranged to provide an electrochemical “shutter” for the chemically active area 12, in the bottom of the well 14, in the following way. A moderately acidic electrolyte 16 is applied to the upper surface of the structure and a suitable potential is applied across the relevant wells, as described above with reference to FIG. 2. As illustrated in FIG. 3b, the electrolyte can then enter cells 14, where no electrical potential has been applied. On the other hand, as shown in FIG. 3c, where an electrical potential has been applied, the water of the electrolyte will be electrolysed to yield oxygen and hydrogen, which in the normal way, can dissolve in the electrolyte. However, if they are generated (particularly from the lower electrode 4) faster than they can dissolve, then a gas bubble will form and grow to the shape shown in FIG. 3c. The result of this is the formation of a gas column, with a bubble 18 at its upper end, which protects the chemically reactive area 12 in the lower region of the well, from the chemical reaction.

A sustaining electrolysis current will flow in the absorbed water multilayer that will result from the water saturated atmosphere in the bubble. The side walls of the well are preferably treated so as to be hydrophilic.

“Shutter” Characteristics

An approximate idea of the sustaining current required at a single well can be obtained by making use of an early paper “On the stability of gas bubbles in liquid-gas solution” (P. S. Epstein and M. S. Plesset, J.Chem.Phys., 18(1950)1505-1509). Hence the authors deduce the relation for the time, τ, for a bubble of gas (formed instantaneously) of initial radius Rₒ to completely dissolve in water, namely,

τ=Rₒ²/2α

Where α=K(Cₛ−C_{I})/

[symbol]

K is the diffusion coefficient of H₂ or O₂ in water; Cₛ is the saturation solubility of the gas in water C₁ is the initial concentration of the gas in the water; and [symbol] is density of gas in the bubble. The pressure of gas in the bubble, ρᵢₙ, will be related the pressure of gas outside the bubble, ρₒᵤₜ, the bubble radius, R, and the surface tension, γ, of the gas/solution interface given by the equation (first proposed by Laplace),

ρᵢₙ=ρₒᵤₜ+2γ/R

### EXAMPLE

γ: surface tension, Nm⁻¹: water at 22° C. is 7.3×10⁻² Nm⁻¹

Atmospheric pressure: 1 atmos=760 Torr (mmHg); 10⁵ Pa(Nm⁻²)

Henry's Law const.: K_{hydrogen}=5.34×10⁷ Torr and K_{oxygen}=3.30×10⁷ Torr

Diffusion coefficient of hydrogen molecules in water: m² sec⁻¹=5×10⁻⁹ m² sec⁻¹

e: charge on electron=1.6×1−0⁻¹⁹ Coulombs.

N: Avagadro's number=6.02×10²³ particles per mol.

n(H₂O): number of moles in 1 kg of water=55.5

Now suppose that we take the radius of the bubble shown in the diagram 3(c) as 40 nm (400 Å), this is sitting on top of a 25 nm radius well. The external gas pressure will be 0.2 atmosphere for O₂(i.e. 0.2×760 Torr), but zero for hydrogen, and the term 2γ/R=2×7.3×10⁻²/4×10⁻⁸=3.65×10⁶ Pa=36.5 atmospheres=2.74×10⁴ Torr, and clearly we may neglect ρₒᵤₜ:this is a high internal bubble pressure.

The saturation solubility of gas (dependent upon pressure) is given, using Henry's Law, as x=p/K, where x is the mole fraction of solute and ρ is its partial pressure, and K is a materials specific constant. In our case of dilute solutions we may write that the number of moles of gas, n(gas), dissolved in 1 kg of water is,

N(gas)=ρᵢₙn(H₂O)/K

K is given above. So for hydrogen:

ρTorr×55.5 mol

5.34×10⁷ Torr

This is a molality that we approximate easily to a molarity, so n(gas) will be in mol/litre. At 36.5×760 Torr (36.5 atmospheres) we have;

n(H₂)=0.029 mol/litre: and n(0₂)=0.046 mol/litre.

Before calculating the bubble time τ above we need α, in which we take K as

5×10⁻⁹ m²/sec; and C_{g}/ [symbol] is 0.029/(36.5÷22.4)=0.018. So that

α=5×10⁻⁹×0.018=9×10⁻¹¹ m²/sec.

Thus τ is 1.6×10⁻¹⁵/9×10⁻¹¹ sec.=1.8×10⁻³ sec.

The amount of material in moles in a bubble is about (4/3)πRₒ³×(36.5÷22.4)×10³=4.19×(4×10⁻⁸)³×1.63×10³10⁻¹⁹ moles of H₂. This corresponds to a requirement for discharge of, 2×4.37×10⁻¹⁹×6.02×10²³=5×10⁵ electrons per bubble. This would correspond to 5×10⁵/1.9×10⁻3=2.6×10⁸ electrons per second. If the cathode area is 2πR_{w}h(R_{w} is the well radius and h is the thickness if the cathode layer)=6.28×2.5×10⁻⁸×3×10⁻⁸=4.7×10⁻¹⁵ m²: then the sustaining current density is about 5.5×10²² electrons m⁻²=8850 Amps m⁻². Or with a well coverage of about 20% the current densities are 0.18 Amps cm⁻²; 1.8 milliamps mm⁻²; or 1.8×10⁻⁹ Amps/sq. micron. This is an upper limit estimate.

A modest current density will be able to sustain a gas shutter over the bottom of the well area, and on turning the current off the shutter will go in the order of a millisecond.

Multiplexing

The equilibrium discharge potential for the electrolysis of water is 1.23 volts. The current/voltage characteristics, I/V, of the anode and cathode are both non-linear and best described by an equation of the form,

I=Iₒexp(seV/kT)

where Iₒ is the exchange current s is a constant depending on the mechanism of discharge but often equal to 2 and e/kT has its usual meaning. This equation is similar in form to that of a forward biased diode. It is this type of relation that makes multiplexing possible. The basic notion is that a voltage Vₜₕ is required to give the current density for gas shutter formation while Vₜₕ/2 will be well below 1.23 volts and so give no discharge at all. Typical anodic Iₒ values are 10⁻¹⁰ Amps cm⁻².

FIG. 2 shows the notions of a multiplexed array. Note that the metal layers are fabricated into strips (say 1 micron wide) so that they constitute a matrix array N×M.

It should be possible, because of the non-linearity of the I/V characteristic, to select a particular line open while shuttering off all the other lines. This, X^{th}, line will be treated chemically and then closed and the next, (x+1)^{th} line opened and treated, and so forth. There are then N different lines of material attached in the wells. If all the columns except the y^{th} column are shuttered off and then exposed it to a particular reagent, all the N different rows will react with the reagent in their y^{th} column, and so forth until there is a matrix N×M of pixellated reaction products, having carried out N+M operations.

This simple, line-at-a-time multiplexing, does not allow the facility to shutter off all the pixels except one. It does allow for shuttering off one pixel and opening all the others. A more elaborate multiplexing scheme could be envisaged that took advantage of an underlying semiconductor substrate, e.g. silicon, that could be processed into an active matrix array.

FIG. 4 shows an alternative well structure which is similar to that of FIG. 3 but has slightly different layer dimensions. In particular the metal layers are somewhat thicker in that the upper and lower metal layers 18 and 20 are in the region of 100 mm thick.

FIG. 5 illustrates how the matrix structure may be employed in an alternative mode of operation so as to specifically promote a reaction at predetermined reaction sites 22 in particular wells, rather than shuttering them off. In this case a nearly neutral electrolyte solution (pH about 7) is applied to the structure, and a suitable potential then applied to selected parts of the matrix.

In electrolysing a neutral aqueous solution of a salt (e.g. 0.1 molar LiNO₃), excess H⁺ ions and oxygen are produced at the metal anode (20) and excess OH⁻ ions and hydrogen are produced at the cathode (18). At the anode the excess H⁺ charge is compensated by NO₃⁻ ions and at the cathode the excess OH⁻ charge is compensated by Li⁺ ions. If the fractional area of the substrate covered by wells is F (for example one quarter of the outer area exposed to electrolyte might be open well area; F=0.25), the thickness of the anode is A, the thickness of the cathode is C, and the radius of the well is R then the ratio, T, of anode area to cathode area is given by,

T=[(1/F)+(2A/R)]/(2C/R).

For example when F=0.25, A=100 nm, C=100 nm, and R=40 nm, then T=8/5=1.6. In addition to this asymmetry of electrode areas and electrode configurations, there is a difference in the diffusion coefficients of the H⁺ and OH⁻ ions, namely, 9.4×10⁻⁵ cm² s⁻¹ and 5.3×10^{-5 cm}² s⁻¹ respectively. In this, and similar cases, when an electrolysis current is passed between the electrodes through the electrolyte there will be a build-up of OH⁻ ion concentration in the cathode region and particularly in the region of the reaction site on the substrate. In this way effective “de-protection” of chemicals can be accomplished because the OH⁻ concentration is changed. This ion concentration change in the region of the reaction site comes about because:

a) the H⁺ ions are spatially removed from the OH⁻ ions by being generated on the outside of the well;

b) H⁺ ions are generated near the top of the well;

c) H⁺ ions diffuse away into the electrolyte faster than the OH⁻ ions.

In an exemplary case, 40% of the H⁺ are generated on the outer surface and are lost to the bulk electrolyte. Of the remaining 60% of generated H⁺ ions roughly half move out into the bulk electrolyte (again lost) while the other half moves into the lower OH⁻ ion rich area where they react with OH⁻ ions to regenerate water. On this count about 30% of the OH⁻ ions are destroyed and 70% survive. The generation of OH⁻ ions, 70% of which survive, leads to a local change in pH, that can be used to change the chemistry at the reaction site. An approximate value of the concentration build-up of OH⁻ ions generated in the cathode region is obtained from solution of the equation for diffusion into a slab of thickness L at a constant current density, Fₒ,. The concentration, n, is given approximately, for the range of dimensions of interest here, by

$$n = 2.26 {{F}_{o} ( \frac{t}{D} )}^{1 / 2}$$

where D is the diffusion coefficient of OH⁻ions, and t is the time from the start of electrolysis. Typically Fₒ is 1 mAcm⁻² (6.3×10¹⁵ ions cm⁻² s⁻¹) of which 70% is available, t is 1 second and D is 5.3×10⁻⁵ cm² s⁻¹. Then n=8.4×10¹⁹ cm⁻³., i.e. 0.14 molar, which is just over pH 13. Clearly current density and time may be altered as needed.

The structure of the present invention has been devised in response to the need for array synthesis and analysis that is particularly relevant to drug discovery and developmentand the field of medical diagnosis. It does not directly address the question of chemical identification or chemical release at each pixel. However the well defined matrix array structure will readily lend itself to e.g. scanning analytical tools.

1. A method of forming an array of electrically addressable cells, comprising the steps of:
(a) forming a set of parallel conductor strips, extending in a first direction, on an insulating substrate;
(b) forming an insulating layer superimposed on the first series of parallel strips;
(c) forming a second set of parallel conductor strips, extending in a direction at right angles to the first direction, superimposed on the insulating layer so as to form crossover regions between the strips, and
(d) forming wells in the structure which extend through the conductor strips, so that the wells at the crossover regions can be addressed electronically in the conductor strips.

2. A method according to claim 1 in which the wells are formed by a process comprising the steps of
a) depositing a very thin film of a highly soluble solid onto a flat hydrophilic substrate;
b) exposing the film to solvent vapour under controlled conditions so that the film reorganizes into an array of discrete hemispherical islands on the surface;
c) depositing a film of a suitable conductive resist material over the whole surface;
d) removing the hemispherical structures together with their coating of resist leaving a resist layer with an array of holes corresponding to the islands; and
e) subjecting the resulting structure to a suitable etching process so as to form a well at the position of each hole.

3. A method according to claim 1 in which the wells are formed by electron beam lithography X-ray lithography, or deep UV lithography.

4. A Method according to any one of the preceding claims claim 1 in which the substrate is comprises silicon with an insulating layer of SiO₂.

5. A method according to any one of the preceding claims claim 1 in which the conductor strips are comprise gold or silver.

6. A method according to claim 2 in which the highly soluble solid is comprises a salt.

7. A method according to claim 6 in which the salt is comprises cesium chloride.

8. A method according to claim 6 or claim 7 in which the solvent is comprises water.

9. A method according to claim 2 in which the resist material is comprises vapour-deposited aluminum, silver or chromium.

10. An electrically addressable array or group of cells formed by a method according to any preceding claim 1.

11. A method of selectively reacting a substance with a series of reagents using an electrically addressable array of cells according to claim 10, comprising the steps of:
(a) introducing the substance into the array of cells so as to form a reaction site in each cell;
(b) applying a moderately acidic electrolyte solution to the array, in order to fill all of the cells with electrolyte;
(c) connecting an electrical supply to at least one of the metal strips of each set of the array, so as to address the corresponding group of cells at each crossover region; whereby the water of the electrolyte is electrolysed to produce a gas bubble at each addressed cell which protects the reaction site;
(d) applying a reagent onto the array of cells so that it can only react with the cells which have not been addressed; and
(e) washing excess, unreacted reagent away.

12. A method of selectively reacting a substance with reagents using an electrically addressable array of cells according to claim 10, comprising the steps of:
(a) introducing the substance into the array in order to attach it to the bottom of each cell so as to form a reaction site;
(b) applying a near-neutral electrolyte solution containing a desired reagent to the array, in order to fill all of the cells with solution;
(c) connecting an electrical supply to at least one of the metal strips of each set of the array, so as to address the corresponding group of cells at each crossover region; whereby the pH of the solution is changed locally in the reaction site of each addressed cell, which allows the reagent to react only at the addressed sites.

13. A method according to claim 2 in which the substrate comprises silicon with an insulating layer of SiO₂.

14. A method according to claim 2 in which the conductor strips comprise gold or silver.

15. A method according to claim 7 in which the solvent comprises water.
